(19) United States
(12) Patent Application Publication
(10) Pub. No.: US 2025/0246645 A1
(43) Pub. Date: Jul. 31, 2025

(54) SINGLE CELL FOR FUEL CELL

(71) Applicant: TOYOTA BOSHOKU KABUSHIKI KAISHA, Aichi-ken (JP)

(72) Inventors: Haruyuki AONO, Aichi-ken (JP); Akihiro INUKAI, Okazaki-shi (JP); Harutaka ODA, Toyota-shi (JP); Kensuke DOI, Obu-shi (JP); Satoshi KAWABE, Ichinomiya-shi (JP)

(73) Assignee: TOYOTA BOSHOKU KABUSHIKI KAISHA, Aichi-ken (JP)

(21) Appl. No.: 19/026,946

(22) Filed: Jan. 17, 2025

(30) Foreign Application Priority Data
Jan. 25, 2024 (JP) 2024-009344

(51) Int. Cl. H01M 8/0263; H01M 8/0254; H01M 8/1004

(52) U.S. Cl. CPC H01M 8/0263; H01M 8/0254; H01M 8/1004

(57) ABSTRACT

A single cell for a fuel cell includes a power generating unit and two separators. Each separator includes a surface that faces the power generating unit, and includes gas passages. Each gas passage includes first extensions and a second extension. The second extension connects a downstream end of one of two adjacent first extensions and an upstream end of the other first extension to each other. A first rib is provided between adjacent ones of the first extensions. A second rib is provided on each first rib. The second rib of one of the two separators and the second rib of the other separator extend so as to intersect with each other when viewed in the direction in which the separators sandwich the power generating unit.

### CROSS-REFERENCE TO RELATED APPLICATIONS

This application is based upon and claims the benefit of priority from Japanese Patent Application No. 2024-009344, filed on Jan. 25, 2024, the entire contents of which are incorporated herein by reference.

### BACKGROUND

### 1. Field

The present disclosure relates to a single cell for a fuel cell.

### 2. Description of Related Art

A typical fuel cell includes a cell stack body, which is formed by stacking single cells, and two end plates that sandwich the cell stack body in a stacking direction of the single cells. Japanese Laid-Open Patent Publication No. 2013-69541 discloses an example of a single cell for a fuel cell. This single cell includes a membrane electrode assembly and two separators that sandwich the membrane electrode assembly, and has the shape of a rectangular plate as a whole. Two gas diffusion layers are disposed between the membrane electrode assembly and the two separators.

Each separator includes a gas passage on a surface facing the membrane electrode assembly. Reactant gas flows through the gas passage. The gas passage includes recesses formed through pressing. In one of the two separators, the gas passage is a meandering “serpentine” passage, which is defined by multiple straight ribs. In a case of a serpentine gas passage, so-called bypass flows may occur, in which reactant gas bypasses the ribs and flows through the gas diffusion layer via pores in regions of the gas diffusion layer that are in contact with the ribs.

To suppress such bypass flows, a protrusion is formed on a portion of each rib to extend linearly along the rib. These protrusions protrude from the ribs to the gas diffusion layer and are embedded into the gas diffusion layer. The protrusions partially compress the gas diffusion layer and thus reduce the number of pores through which reactant gas can pass in portions into which the protrusions are embedded. This suppresses the occurrence of bypass flows in the portions of the gas diffusion layer compressed by the protrusions.

However, in the single cell described above, when the gas passages of both separators are serpentine, forming the above-described protrusions on the ribs to suppress the occurrence of bypass flows is problematic.

For example, if two gas diffusion layers are sandwiched by two separators, the protrusions of one of the two separators and the protrusions of the other separator overlap with each other when viewed in the direction in which the separators sandwich the membrane electrode assembly. In this case, since the protrusions extend linearly, if the positions of the two separators are displaced from each other in a direction orthogonal to the sandwiching direction, the protrusions of the two separators may not overlap at all when viewed in the sandwiching direction.

As a result, when multiple single cells are manufactured, some single cells may be produced with protrusions of two separators completely overlapping with each other when viewed in the sandwiching direction, while others may be produced with protrusions not overlapping with each other at all. In such a case, among the multiple single cells, there is a significant difference in the compression ratio of the two gas diffusion layers caused by the protrusions of the two separators, depending on whether the protrusions perfectly overlap with each other or do not overlap with each other at all when viewed in the sandwiching direction.

This leads to a problem where there is a large variation in pressure loss of the reactant gases flowing through the gas diffusion layers among the multiple single cells in the fuel cell.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a single cell for a fuel cell includes a power generating unit that includes a membrane electrode assembly and two gas diffusion layers sandwiching the membrane electrode assembly, and two separators that sandwich the power generating unit. Each separator includes a surface facing the power generating unit. The surface facing the power generating unit is provided with a gas passage configured to allow a reactant gas to flow through the gas passage. The gas passage includes multiple first extensions that extend in a first direction and are arranged in parallel in an orthogonal direction that is orthogonal to the first direction, and a second extension that is connected to ends in the first direction of the first extensions and extends in a second direction that is different from the first direction. Flow directions of the reactant gas in the first extensions adjacent to each other in the orthogonal direction are opposite to each other. The second extension connects a downstream end in the flow direction of one of the first extensions adjacent to each other in the orthogonal direction to an upstream end in the flow direction of another of the first extensions. A first rib is provided between the first extensions adjacent to each other in the orthogonal direction, the first rib separating the first extensions from each other and extending in the first direction. A second rib extending in the first direction is provided on the first rib. The second rib of one of the two separators and the second rib of the other separator extend so as to intersect with each other when viewed in a direction in which the separators sandwich the power generating unit.

Other features and aspects will be apparent from the following detailed description, the drawings, and the claims.

### BRIEF DESCRIPTION OF THE DRAWINGS

FIG. 1 is a cross-sectional view of a fuel cell stack according to an embodiment.

FIG. 2 is an exploded perspective view of a single cell shown in FIG. 1.

FIG. 3 is a plan view of gas passages of a separator shown in FIG. 1.

FIG. 4 is a partially enlarged view of FIG. 3.

FIG. 5 is a schematic cross-sectional view taken along line 5-5 of FIG. 4.

FIG. 6 is a schematic plan view showing a portion of a single cell shown in FIG. 1.

FIG. 7 is a cross-sectional view showing part of a single cell shown in FIG. 1.

FIG. 8 is a cross-sectional view showing part of a single cell shown in FIG. 1.

FIG. 9 is a schematic cross-sectional view of a second rib according to a modification.

FIG. 10 is a schematic cross-sectional view of a second rib according to a modification.

FIG. 11 is a schematic plan view illustrating a state in which second ribs of two separators overlap with each other in a single cell according to a modification.

FIG. 12 is a schematic plan view illustrating a state in which second ribs of two separators overlap with each other in a single cell according to a modification.

FIG. 13 is a schematic plan view illustrating a state in which second ribs of two separators overlap with each other in a single cell according to a modification.

FIG. 14 is a schematic plan view illustrating a state in which second ribs of two separators overlap with each other in a single cell according to a modification.

FIG. 15 is a schematic plan view illustrating a state in which second ribs of two separators overlap with each other in a single cell according to a modification.

FIG. 16 is a schematic plan view illustrating a state in which second ribs of two separators overlap with each other in a single cell according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment will now be described with reference to the drawings.

### Fuel Cell Stack 11

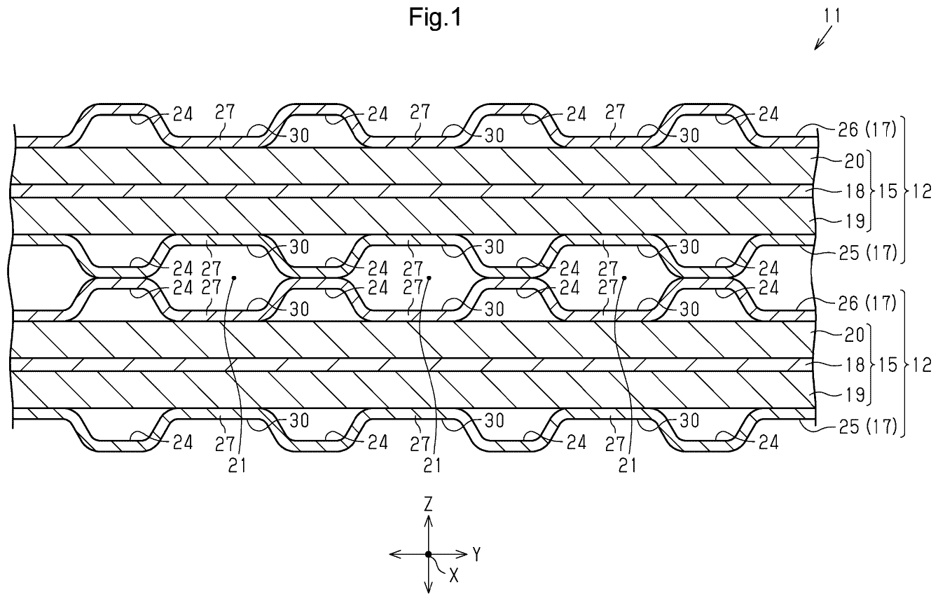

As shown in FIG. 1, a fuel cell stack 11 includes multiple single cells 12 stacked together.

### Single Cell 12

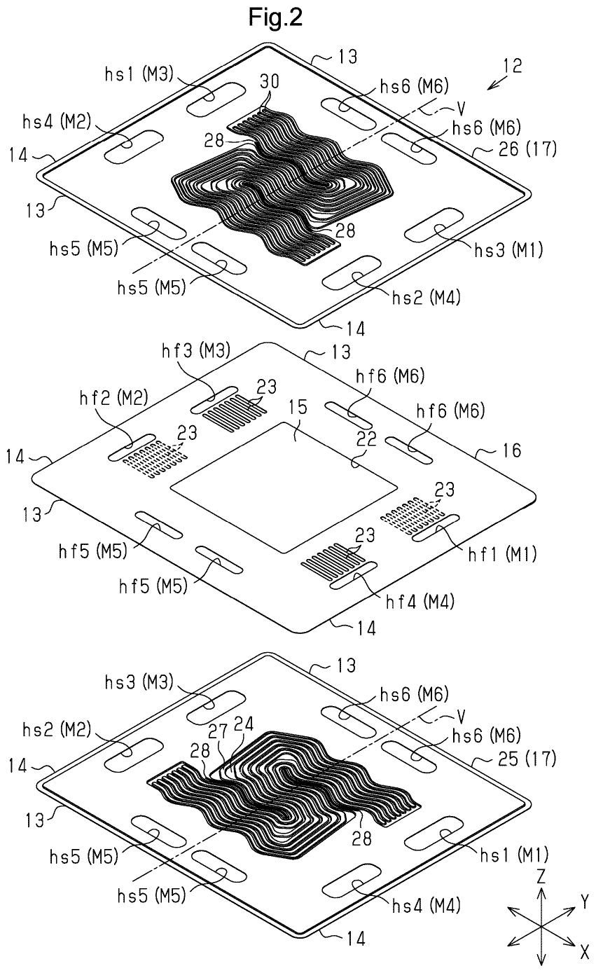

As shown in FIG. 2, the single cell 12 has the shape of, for example, a square plate. That is, the single cell 12 includes two first sides 13, which extend parallel to each other, and two second sides 14, which are orthogonal to the first sides 13 and extend parallel to each other.

In the following description, the direction in which the single cells 12 are stacked will simply be referred to as a stacking direction Z. The direction in which the first sides 13 extend will be referred to as a direction of an X-axis (X-axis direction), and the direction in which the second sides 14 extend will be referred to as a direction of a Y-axis (Y-axis direction). The stacking direction Z, the X-axis direction, and the Y-axis direction are orthogonal to one another.

The single cell 12 includes a fuel gas supply manifold M1, which supplies fuel gas to the interior of the single cell 12, and a fuel gas discharge manifold M2, which discharges fuel gas to the outside of the single cell 12. The single cell 12 includes an oxidant gas supply manifold M3, which supplies oxidant gas to the interior of the single cell 12, and an oxidant gas discharge manifold M4, which discharges oxidant gas to the outside of the single cell 12.

The manifolds M1 to M4 each have, for example, the shape of a stadium elongated in the Y-axis direction. The fuel gas supply manifold M1 and the oxidant gas discharge manifold M4 are located at the end of the single cell 12 on one side in the X-axis direction and arranged in this order from the one side to the other side in the Y-axis direction.

The fuel gas discharge manifold M2 and the oxidant gas supply manifold M3 are located at the end of the single cell 12 on the other side in the X-axis direction, which is opposite to the one side, and arranged in this order from the other side to the one side in the Y-axis direction. The fuel gas is, for example, hydrogen. The oxidant gas is, for example, air.

As shown in FIGS. 1 and 2, each single cell 12 includes two cooling medium supply manifolds M5, which supply cooling medium to the interior of the fuel cell stack 11, and two cooling medium discharge manifolds M6, which discharge cooling medium to the outside of the fuel cell stack 11. The cooling medium supply manifolds M5 and the cooling medium discharge manifolds M6 each have, for example, the shape of a stadium elongated in the X-axis direction.

The two cooling medium supply manifolds M5 are located at the end on the other side of the single cell 12 in the Y-axis direction and spaced apart from each other in the X-axis direction. The two cooling medium discharge manifolds M6 are located at the end of the single cell 12 on the one side in the Y-axis direction and spaced apart from each other in the X-axis direction. The cooling medium is, for example, water.

The single cell 12 includes a power generating unit 15, a frame 16, and two separators 17. The power generating unit 15 has the shape of a sheet. The frame 16 surrounds the outer edge of the power generating unit 15. The two separators 17 sandwich the power generating unit 15 and the frame 16 between them from the opposite sides in the stacking direction Z. The stacking direction Z is an example of “the direction in which two separators 17 sandwich a power generating unit 15”. The power generating unit 15 and the separator 17 have, for example, a square shape in plan view. The frame 16 has, for example, a square frame shape in plan view.

### Power Generating Unit 15

As shown in FIG. 1, each power generating unit 15 includes a membrane electrode assembly 18, an anode-side gas diffusion layer 19, and a cathode-side gas diffusion layer 20. The anode-side gas diffusion layer 19 and the cathode-side gas diffusion layer 20 sandwich the membrane electrode assembly 18. The anode-side gas diffusion layer 19 and the cathode-side gas diffusion layer 20 are examples of “two gas diffusion layers”. Although not illustrated, the membrane electrode assembly 18 includes an electrolyte membrane, an anode electrode catalyst layer and a cathode electrode catalyst layer. The anode electrode catalyst layer and the cathode electrode catalyst layer sandwich the electrolyte membrane. The anode-side gas diffusion layer 19 is stacked on the anode electrode catalyst layer. The cathode-side gas diffusion layer 20 is stacked on the cathode electrode catalyst layer.

The fuel gas is supplied to the anode-side surface of the power generating unit 15 through the fuel gas supply manifold M1. The oxidant gas is supplied to the cathode-side surface of the power generating unit 15 through the oxidant gas supply manifold M3. As a result, the power generating unit 15 generates power from the electrochemical reaction between the fuel gas and the oxidant gas.

In the fuel cell stack 11, each single cell 12 generates heat during the power generation of the power generating unit 15. Thus, the fuel cell stack 11 includes cooling passages 21, which will be described later. The cooling medium is supplied to the cooling passages 21 through the cooling medium supply manifolds M5.

### Frame 16

As shown in FIG. 2, the frame 16 is made of an insulating plastic. The frame 16 includes an accommodating hole 22 at its middle portion to accommodate the power generating unit 15. The frame 16 includes through-holes hf1 to hf6, which respectively define manifolds M1 to M6, on the outer side of the accommodating hole 22. The frame 16 includes multiple grooves 23 between the accommodating hole 22 and each of the through-holes hf1 to hf4.

The grooves 23 formed between the accommodating hole 22 and the through-holes hf1, hf2, and the grooves 23 formed between the accommodating hole 22 and the through-holes hf3, hf4 are disposed on the opposite sides of the frame 16 in the stacking direction Z. In other words, the grooves 23 formed between the accommodating hole 22 and the through-holes hf1, hf2 are disposed on one of the opposite surfaces of the frame 16 in the stacking direction Z. The grooves 23 formed between the accommodating hole 22 and the through-holes hf3, hf4 are disposed on the other one of the opposite surfaces of the frame 16 in the stacking direction Z.

The grooves 23 are arranged in parallel and spaced apart from each other in the Y-axis direction. Each groove 23 has the shape of a stadium elongated in the X-axis direction. One end of each groove 23 is continuous with one of through-holes hs1 to hs4 of the separator 17, which will be described later, in the stacking direction Z. The other end of each groove 23, which is opposite to the one end, is continuous with the gas passages 24 of the separator 17, which will be described later, in the stacking direction. Each of the manifolds M1 to M4 is continuous with the gas passages 24 through, for example, seven grooves 23.

### Separator 17

As shown in FIGS. 1 and 2, each separator 17 is formed by pressing a metal (e.g., stainless steel or titanium alloy) plate. One of the two separators 17 is disposed on the anode-side surface of the power generating unit 15, and the other separator 17 is disposed on the cathode-side surface of the power generating unit 15.

In the following description, the separator 17 located on the anode-side surface of the power generating unit 15 may be referred to as an anode separator 25, and the separator 17 located on the cathode-side surface of the power generating unit 15 may be referred to as a cathode separator 26.

The anode separator 25 and the cathode separator 26 have an identical configuration. The anode separator 25 and the cathode separator 26 are arranged in orientations that are inverted relative to each other about a virtual axis V, with respect to the power generating unit 15. The virtual axis V passes through the center of the separator 17 in the X-axis direction and extends in the Y-axis direction.

The separator 17 includes through-holes hs1 to hs6, which respectively define the manifolds M1 to M6. As described above, the anode separator 25 and the cathode separator 26 are arranged in orientations that are inverted with respect to the power generating unit 15. Thus, the through-hole hs1 of the anode separator 25 is continuous with the through-hole hs3 of the cathode separator 26, and the through-hole hs2 of the anode separator 25 is continuous with the through-hole hs4 of the cathode separator 26.

The through-hole hs3 of the anode separator 25 is continuous with the through-hole hs1 of the cathode separator 26, and the through-hole hs4 of the anode separator 25 is continuous with the through-hole hs2 of the cathode separator 26. The through-hole hs5 of the anode separator 25 and the through-hole hs5 of the cathode separator 26 are continuous with each other, and the through-hole hs6 of the anode separator 25 and the through-hole hs6 of the cathode separator 26 are continuous with each other.

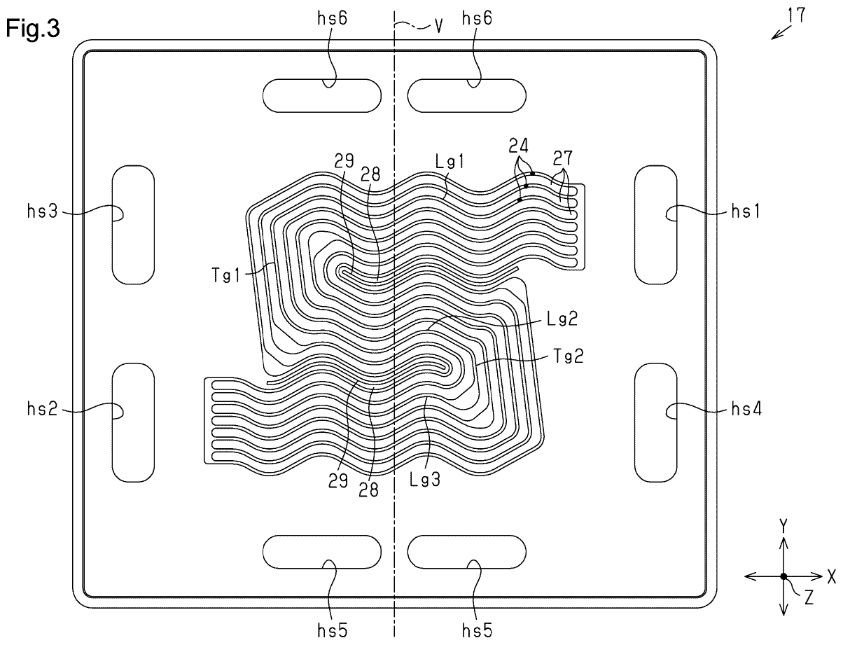

As shown in FIG. 3, groove-shaped gas passages 24 and ribs 27 are alternately arranged on the surface of the separator 17 that faces the power generating unit 15. Reactant gas flows through the gas passages 24. The ribs 27 extend along the gas passages 24. The separator 17 includes, for instance, eight gas passages 24 extending parallel to each other. The shape of each gas passage 24 is a serpentine shape, extending in a meandering manner from the through-hole hs1 to the through-hole hs2.

As shown in FIGS. 2 and 3, fuel gas flows through the gas passages 24 of the anode separator 25 as reactant gas. Oxidant gas flows through the gas passages 24 of the cathode separator 26 as reactant gas. The reactant gases are supplied to the power generating unit 15 by flowing through the gas passages 24. The reactant gases in the fuel cell stack 11 are supplied using, for example, a counter-flow method where fuel gas and oxidant gas flow in opposite directions.

Hereinafter, the upstream side in the flow direction of reactant gases through the gas passages 24 is simply referred to as an upstream side, and the downstream side in the flow direction is simply referred to as a downstream side.

Each gas passage 24 is formed into a substantially S-shape by connecting first extensions Lg1 to Lg3 to each other by second extensions Tg1, Tg2. Reactant gas flows sequentially through the first extension Lg1, the second extension Tg1, the first extension Lg2, the second extension Tg2, and the first extension Lg3. The first extensions Lg1 to Lg3 are arranged adjacent to each other in the Y-axis direction. The first extensions Lg1 to Lg3 extend in the X-axis direction while meandering in a wavy manner. The X-axis direction is an example of a “first direction”. The Y-axis direction, which is orthogonal to the X-axis direction, is an example of an “orthogonal direction”.

The second extensions Tg1 and Tg2 extend straight, inclined relative to the virtual axis V, such that they are positioned progressively closer to one side in the X-axis direction as they extend downstream. The direction in which the second extensions Tg1 and Tg2 extend is an example of a “second direction”, which is different from the “first direction”.

The upstream ends of the first extensions Lg1 are connected to the through-hole hs1 through the grooves 23 of the frame 16. The second extensions Tg1 connect the downstream ends of the first extensions Lg1 to the upstream ends of the first extensions Lg2. The second extensions Tg2 connect the downstream ends of the first extensions Lg2 to the upstream ends of the first extensions Lg3. The downstream ends of the first extensions Lg3 are connected to the through-hole hs2 through the grooves 23.

When reactant gas flows from the first extensions Lg1 to the first extensions Lg2 through the second extensions Tg1 and flows from the first extensions Lg2 to the first extensions Lg3 through the second extensions Tg2, the flow direction of the reactant gas reverses. Thus, the second extensions Tg1 and Tg2 each define a fold-back portion of each gas passage 24. The first extensions Lg1, Lg3 and the first extensions Lg2, which are adjacent to each other in the Y-axis direction, have flow directions for the reactant gas that are opposite to each other along the X-axis.

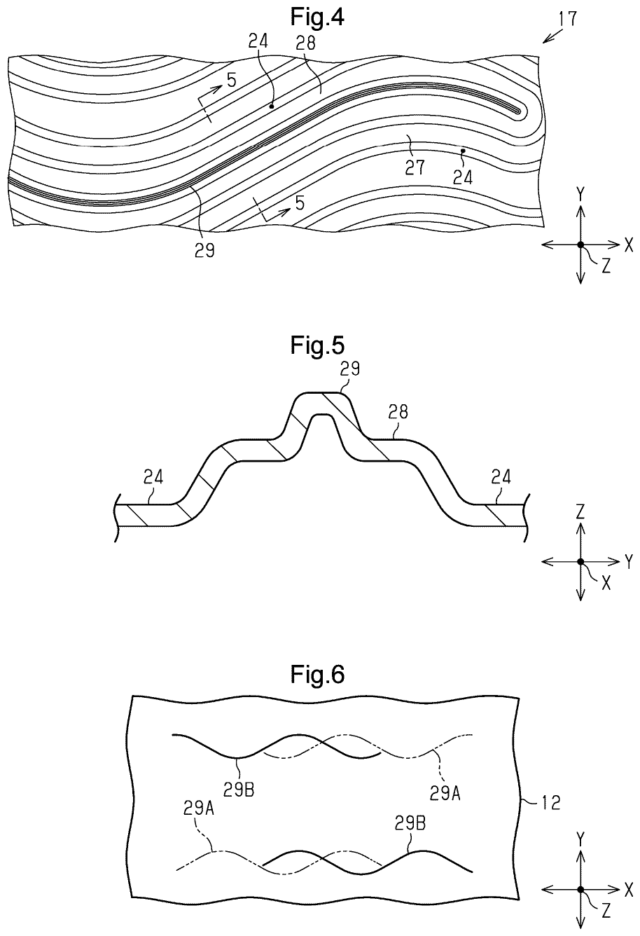

As shown in FIGS. 3 to 5, first ribs 28, which extend in the X-axis direction, are provided between a first extension Lg1 and a first extension Lg2 that are adjacent to each other in the Y-axis direction, and between a first extension Lg2 and a first extension Lg3 that are adjacent to each other in the Y-axis direction. The first rib 28 provided between the first extension Lg1 and the first extension Lg2 separates the first extension Lg1 and the first extension Lg2 from each other. The first rib 28 provided between the first extension Lg2 and the first extension Lg3 separates the first extension Lg2 and the first extension Lg3 from each other.

The first rib 28 that separates the first extension Lg1 and the first extension Lg2 from each other extends in the X-axis direction, while meandering in a wavy manner along the first extension Lg1 and the first extension Lg2. The first rib 28 that separates the first extension Lg2 and the first extension Lg3 from each other extends in the X-axis direction, while meandering in a wavy manner along the first extension Lg2 and the first extension Lg3.

A second rib 29 is disposed on each first rib 28. The second rib 29 extends in the X-axis direction while meandering in a wavy manner along the first rib 28 and is disposed on the middle part of the first rib 28 in the width direction. The second rib 29 extends substantially over the entire first rib 28 in the X-axis direction. The first rib 28 and the second rib 29 are, for example, substantially trapezoidal when viewed in cross section.

In the following description, the second ribs 29 of the anode separator 25 may be referred to as second ribs 29A, and the second ribs 29 of the cathode separator 26 may be referred to as second ribs 29B.

As shown in FIG. 6, the second ribs 29A of the anode separator 25, which is one of the two separators 17 of the single cell 12, and the second ribs 29B of the cathode separator 26, which is the other separator 17, extend so as to intersect with each other when viewed in the stacking direction Z. In other words, the phase in the X-axis direction of the second ribs 29A and the phase in the X-axis direction of the second ribs 29B are displaced from each other when viewed in the stacking direction Z. Therefore, when the second ribs 29A and the second ribs 29B are regarded as lines, each second rib 29A and the corresponding second rib 29B intersect at a point when viewed in the stacking direction Z, without overlapping with each other continuously over a range of a certain length or more.

### Cooling Passage 21

As shown in FIG. 1, in the fuel cell stack 11, the anode separator 25 of one of two single cells 12 adjacent to each other in the stacking direction is in contact with the cathode separator 26 of the other single cell 12. In the two single cells 12 adjacent to each other in the stacking direction Z, cooling passages 21, through which cooling medium flows, are formed between the anode separator 25 and the cathode separator 26. A gasket (not shown) is arranged between the anode separator 25 and the cathode separator 26, which are in contact with each other, to provide a seal between the two single cells 12.

As shown in FIGS. 1 and 2, the separators 17 each include cooling grooves 30, which define the cooling passages 21. The cooling grooves 30 are located on the surface of each separator 17 that is opposite to the surface having the gas passages 24. The cooling grooves 30 are formed in conformance with the shapes of the rear surface of the ribs 27. Each cooling groove 30 has a serpentine shape extending in a meandering manner from the through-hole hs1 to the through-hole hs2.

The cooling passages 21 are formed by the gaps between the cooling grooves 30 of the anode separator 25 and the cooling grooves 30 of the cathode separator 26. The cooling medium supplied from the cooling medium supply manifold M5 flows through the cooling passages 21 and is then discharged from the cooling medium discharge manifold M6.

### Operation of Embodiment

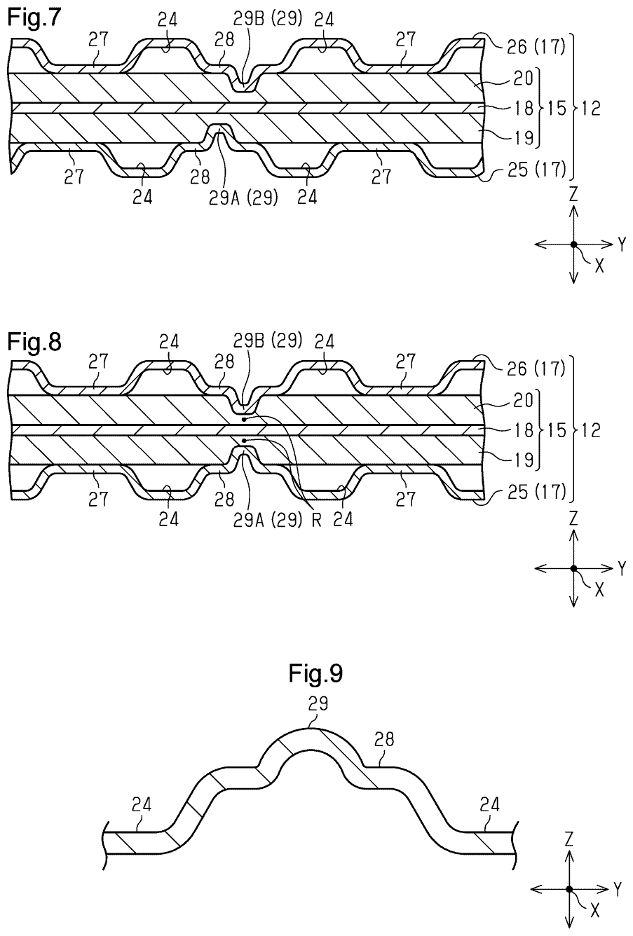

As shown in FIG. 7, in each single cell 12, the second ribs 29A of the anode separator 25 press into the anode-side gas diffusion layer 19, while the second ribs 29B of the cathode separator 26 press into the cathode-side gas diffusion layer 20. The regions of the gas diffusion layers 19, 20 into which the second ribs 29A, 29B press are compressed, resulting in higher pressure loss of the flow of the reactant gas in these regions compared to other regions. Accordingly, the reactant gas is restricted from flowing across the first rib 28 between the first extension Lg1 and the first extension Lg2 that are adjacent to each other in the Y-axis direction, without passing through the second extension Tg1. Also, the reactant gas is restricted from flowing across the first rib 28 between the first extension Lg2 and the first extension Lg3 that are adjacent to each other in the Y-axis direction, without passing through the second extension Tg2.

In this case, as shown in FIG. 6, the second ribs 29A, 29B extend in the X-axis direction while meandering in a wavy manner and extend so as to intersect with each other when viewed in the stacking direction Z. The positions of the second ribs 29A, 29B may be slightly displaced, for example, in a direction orthogonal to the stacking direction Z, such as the X-axis direction or the Y-axis direction, due to an error when the single cell 12 is assembled.

As shown in FIG. 8, in the gas diffusion layers 19, 20, regions in which the second ribs 29A, 29B overlap with each other when viewed in the stacking direction Z are referred to as high compression regions R, in which the compression ratio is significantly high, since these regions are compressed by the second ribs 29A, 29B from the opposite sides in the stacking direction Z. The pressure loss that occurs when the reactant gas flows through is significantly high in the high compression regions R.

Therefore, the pressure loss when the reactant gas flows increases in a single cell 12 in which the high compression regions R are continuously formed over a range of a certain length or more in the gas diffusion layers 19, 20. In contrast, the pressure loss when the reactant gas flows is suppressed to be low in a single cell 12 in which the high compression regions R are not continuously formed over a range of a certain length or more in the gas diffusion layers 19, 20 as shown in FIG. 7.

When the variation in pressure loss of the flowing reactant gas increases among the multiple single cells 12 in the fuel cell stack 11, the variation in the amount of the flowing reactant gas also increases. This results in a risk of decreased power generation performance of the fuel cell stack 11.

In this regard, in the single cell 12 of the present embodiment, the second ribs 29A, 29B overlap with each other at a point when viewed in the stacking direction Z without overlapping with each other continuously over a range of a certain length or more, regardless of whether the positions of the second ribs 29A, 29B are displaced from each other in a direction orthogonal to the stacking direction Z. In other words, in the single cell 12 of the present embodiment, the high compression regions R are not continuously formed over a range of a certain length or more in the gas diffusion layers 19, 20, regardless of whether the positions of the second ribs 29A, 29B are displaced from each other in a direction orthogonal to the stacking direction Z.

Accordingly, in the single cell 12 of the present embodiment, the pressure loss of the reactant gas flowing through the gas diffusion layers 19, 20 does not change significantly regardless of whether the positions of the second ribs 29A, 29B are displaced in a direction orthogonal to the stacking direction Z. Therefore, since the variation in pressure loss of the flowing reactant gas is reduced among the multiple single cells 12 in the fuel cell stack 11, the variation in the amount of the flowing reactant gas also decreases. This, in turn, reduces the risk of decreased power generation performance of the fuel cell stack 11.

### Advantages of Embodiment

The above-described embodiment achieves the following advantages.

(1) In the single cell 12, the second rib 29A of the anode separator 25 and the second rib 29B of the cathode separator 26 extend so as to intersect with each other when viewed in the stacking direction Z.

With this configuration, the above-described operation of the embodiment reduces the variation in pressure loss of the flowing reactant gas among the multiple single cells 12 in the fuel cell stack 11. This, in turn, reduces the variation in the amount of the flowing reactant gas. This reduces the risk of decreased power generation performance of the fuel cell stack 11.

(2) In the single cell 12, the first extensions Lg1 to Lg3 extend in the X-axis direction while meandering in a wavy manner.

With this configuration, when the fuel cell stack 11 is formed by stacking multiple single cells 12, the cooling medium flows more smoothly through the cooling passage 21 between the single cells 12 adjacent to each other in the stacking direction Z than in a case in which the first extensions Lg1 to Lg3 extend linearly in the X-axis direction.

(3) In the single cell 12, the second rib 29A of the anode separator 25 and the second rib 29B of the cathode separator 26 extend in the X-axis direction while meandering in a wavy manner. The phase of the second rib 29A and the phase of the second rib 29B are displaced from each other when viewed in the stacking direction Z.

With this configuration, since the second ribs 29A, 29B extend in the X-axis direction while meandering in a wavy manner along the first extensions Lg1 to Lg3 of the gas passages 24, excess space is unlikely to be created. This allows the space within the single cell 12 to be utilized effectively, which contributes to miniaturization of the single cell 12. In addition, the phases of the second ribs 29A, 29B are displaced from each other when viewed in the stacking direction Z, so that the same advantage as the above-described advantage (1) is achieved.

(4) In the single cell 12, the anode separator 25 and the cathode separator 26 have an identical configuration.

This configuration reduces the number of components in the single cell 12 as compared with a case in which the anode separator 25 and the cathode separator 26 have different configurations.

### Modifications

The above-described embodiment may be modified as follows. The above-described embodiment and the following modifications can be combined as long as the combined modifications remain technically consistent with each other.

As shown in FIG. 9, the second rib 29 may be, for example, semicircular in cross section.

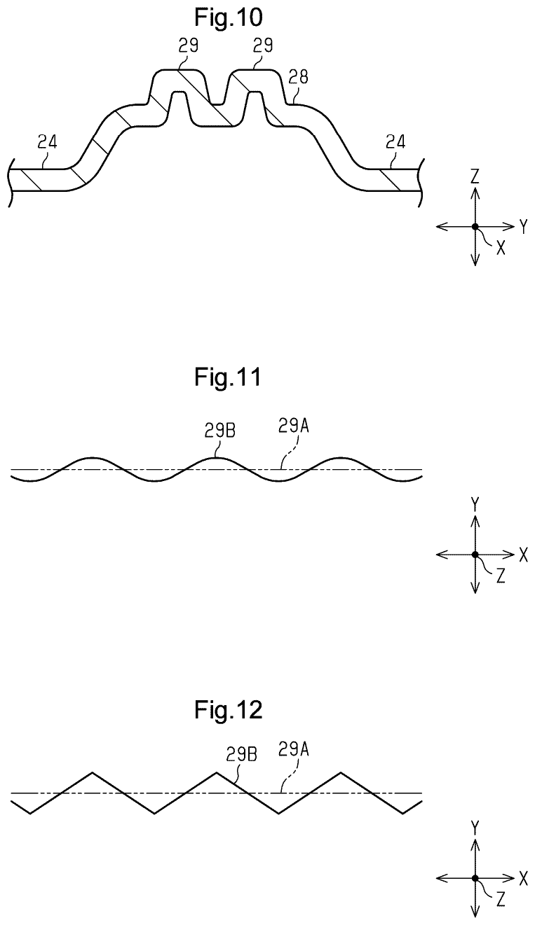

As shown in FIG. 10, two second ribs 29 may be disposed on the first rib 28 and arranged next to each other in the Y-axis direction. Alternatively, three or more second ribs 29 may be arranged in the Y-axis direction on the first rib 28.

As shown in FIG. 11, the second rib 29A may extend linearly in the X-axis direction. Alternatively, the second rib 29B may extend linearly in the X-axis direction. In either case, the second rib 29A and the second rib 29B extend so as to intersect with each other when viewed in the stacking direction Z.

As shown in FIG. 12, the second rib 29A may extend linearly in the X-axis direction, and the second rib 29B may extend in a zigzag manner in the X-axis direction. Alternatively, the second rib 29B may extend linearly in the X-axis direction, and the second rib 29A may extend in a zigzag manner in the X-axis direction. In either case, the second rib 29A and the second rib 29B extend so as to intersect with each other when viewed in the stacking direction Z.

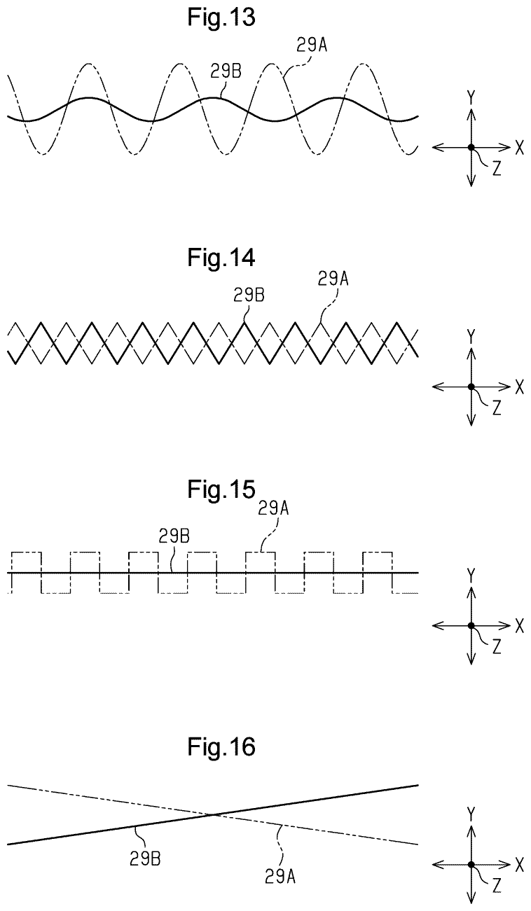

As shown in FIG. 13, the second rib 29A and the second rib 29B may extend in the X-axis direction while meandering in wavy manners having different amplitudes and wavelengths. In this case, the second rib 29A and the second rib 29B extend so as to intersect with each other when viewed in the stacking direction Z.

As shown in FIG. 14, the second rib 29A and the second rib 29B may both extend in a zigzag manner in the X-axis direction. In this case, the second rib 29A and the second rib 29B extend so as to intersect with each other when viewed in the stacking direction Z.

As shown in FIG. 15, the second rib 29A may be configured to extend in the X-axis direction while meandering in a rectangular-wave shape (square-wave shape), and the second rib 29B may be configured to extend linearly in the X-axis direction. Alternatively, the second rib 29B may be configured to extend in the X-axis direction while meandering in a rectangular-wave shape (square-wave shape), and the second rib 29A may be configured to extend linearly in the X-axis direction. In either case, the second rib 29A and the second rib 29B extend so as to intersect with each other when viewed in the stacking direction Z.

As shown in FIG. 16, the second rib 29A and the second rib 29B may extend linearly and intersect with each other at one point when viewed in the stacking direction Z.

In the single cell 12, the anode separator 25 and the cathode separator 26 may have different configurations.

The second extensions Tg1, Tg2 may extend in the Y-axis direction, which is orthogonal to the X-axis direction in which the first extensions Lg1 to Lg3 extend. In other words, the second extensions Tg1, Tg2 may extend in a direction in which the virtual axis V extends.

The second extensions Tg1, Tg2 may extend while meandering in a wavy manner.

The reactant gases in the fuel cell stack 11 may be supplied using, for example, a co-flow method where fuel gas and oxidant gas flow in the same direction in the first extensions Lg1 to Lg3.

The first extensions Lg1 to Lg3 may extend linearly in the X-axis direction.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A single cell for a fuel cell, comprising:
a power generating unit that includes a membrane electrode assembly and two gas diffusion layers sandwiching the membrane electrode assembly; and
two separators that sandwich the power generating unit, wherein
each separator includes a surface facing the power generating unit, the surface facing the power generating unit being provided with a gas passage configured to allow a reactant gas to flow through the gas passage,
the gas passage includes:
multiple first extensions that extend in a first direction and are arranged in parallel in an orthogonal direction that is orthogonal to the first direction; and
a second extension that is connected to ends in the first direction of the first extensions and extends in a second direction that is different from the first direction,
flow directions of the reactant gas in the first extensions adjacent to each other in the orthogonal direction are opposite to each other,
the second extension connects a downstream end in the flow direction of one of the first extensions adjacent to each other in the orthogonal direction to an upstream end in the flow direction of another of the first extensions,
a first rib is provided between the first extensions adjacent to each other in the orthogonal direction, the first rib separating the first extensions from each other and extending in the first direction,
a second rib extending in the first direction is provided on the first rib, and
the second rib of one of the two separators and the second rib of the other separator extend so as to intersect with each other when viewed in a direction in which the separators sandwich the power generating unit.

2. The single cell for the fuel cell according to claim 1, wherein the first extensions extend in the first direction while meandering in a wavy manner.

3. The single cell for the fuel cell according to claim 1, wherein
the second ribs of the two separators extend in the first direction while meandering in a wavy manner, and
phases of the second rib of one of the two separators and the second rib of the other separator are displaced from each other when viewed in a direction in which the separators sandwich the power generating unit.

4. The single cell for the fuel cell according to claim 1, wherein the two separators have an identical configuration.
